(19) United States
(12) Patent Application Publication
(10) Pub. No.: US 2019/0174887 A1
(43) Pub. Date: Jun. 13, 2019

(54) Self Defense Ring

(71) Applicant: Ryan Lee, Brooklyn, NY (US)

(72) Inventor: Ryan Lee, Brooklyn, NY (US)

(21) Appl. No.: 16/213,884

(22) Filed: Dec. 7, 2018

Related U.S. Application Data
(60) Provisional application No. 62/596,572, filed on Dec. 8, 2017.

(51) Int. Cl. A44C 9/00; F41B 15/08

(52) U.S. Cl. CPC A44C 9/0053; B26B 27/007; F41B 15/08

(57) ABSTRACT

The invention provides a ring for use in self-defense including a base with a band that is worn on a finger of a user, a blade fixed to the outer circumference of the band, wherein the blade protrudes from the outer circumference of the band, a base connecting mechanism joined to a portion of the blade that is fixed to the outer circumference of the band, and a ring top comprising a top connecting mechanism, and an ornamental top, wherein the top connecting mechanism is joined to a portion of the ornamental top.

### BACKGROUND OF THE INVENTION

According to the Federal Bureau of Investigation, there were more than 1.25 million violent crimes reported in the United States in 2017, which includes murder, nonnegligent manslaughter, rape, robbery, and aggravated assault. Violent crime affects everyone when it's seen on the news, heard on the radio, or experienced firsthand. Natural differences in height, weight, strength, and speed can create physical disadvantages for smaller and weaker individuals. They can feel vulnerable and defenseless in everyday situations, including, for example, jogging in the park at night, taking a cab alone, or meeting someone for a date. Unfortunately, there can be violent, mentally unstable, or sociopathic individuals who take advantage of these physical vulnerabilities.

Accordingly, individuals can take a proactive stance by seeking ways to protect themselves with self-defense products. The current market for popular self-defense products includes pepper spray, stun guns, pocket knives, and guns. While these self-defense products can be highly effective, they fall short at accessibility, practicality, and functionality.

Pepper spray can come in heavy, bulky bottles, stun guns can be cumbersome to carry, pocket knives can be dangerous to carry, and guns can be illegal to carry. These self-defense products take up valuable space in a user's pocket, bag or purse, and have only one function. All of the current market's self-defense products are burdensome to carry every day and serve only one purpose, making them impractical self-defense weapons.

In a self-defense situation, these products are not readily accessible or available to a user since they would be stored in the user's pocket, bag, or purse. During use, these products can be easily knocked out of a user's hand and can potentially be used against her/him. A user who carries these self-defense products can be perceived as threatening or violent, and some products can be illegal to carry. Additionally, spraying self-defense products can contain fluids that expire over time, may not be potent, and require replenishment. Similarly, electronic self-defense products must be recharged regularly to be effective, and can electronically malfunction during use. In our modern technology-based society, people want things smaller, lighter, readily accessible, and multi-functional.

There is a strong demand for self-defense products, however, existing self-defense products on the market fail to solve problems regarding accessibility, practicality and functionality.

Self-defense jewelry such as self-defense rings have been invented to provide the user with a more readily-accessible self-defense weapon, already mounted on the hand. However, the current market's self-defense rings are not practical and lack aesthetic ornamental appeal. Rings are bought and worn as public displays of style and fashion, and any ring without aesthetic appeal will not be worn. Since attacks are unpredictable, a key feature is that the self-defense ring must be worn regularly to be accessible, and therefore must be an ornamental piece of jewelry.

Prior art includes rings that have blades but are intended for different purposes such as U.S. Pat. No. 579,655 A, Mar. 30, 1897, by W. H. Saladee & J. Cather. The utility patent of Saladee and Cather is similar to the present invention as a ring that you wear on your finger and has a knife. However, the Saladee and Cather invention has the purpose of cutting cloth or twine or ripping stitches or seams instead of being used for self-defense. The Saladee and Cather invention also differs from the present invention in mechanical utility. It does not have a removable ring top and corresponding connecting mechanism. According to the patent description and images, the ring has a blade that lies flat on the ring surface, that can be pivoted and raised to expose the blade. The user must open the blade by lifting it with her fingernail into an elevated position. There are several issues with the Saladee and Cather invention and many differences as it relates to the present invention. One, both inventions serve different purposes and therefore have different features and functions. Two, the Saladee and Cather invention has safety issues regarding the blade. The blade must be opened by the user's finger directly lifting the sharp edge or point of the blade. Three, the blade is also exposed even in the “closed” position and can be accidentally touched or opened. Four, the Saladee and Cather invention is not practical and does not have any aesthetic or ornamental appeal as an everyday piece of jewelry.

Other prior art rings with blades have been invented for self-defense purposes such as U.S. Pat. No. 5,588,214 A, Dec. 31, 1996 by Joe B. Nelson. The utility patent of Nelson is similar to the present invention as a self-defense ring that utilizes a blade. The Nelson invention uses a pair of rings joined together that contain a retractable blade in the center connecting portion located between the two adjoined rings. There are several issues regarding the Nelson invention. One, the invention does not contain a cover and the blade can accidentally be opened thereby creating a safety hazard to the user. Two, the invention requires two fingers to use making it bulky for the user. Three, the Nelson invention is not practical and does not have any aesthetic or ornamental appeal as an everyday piece of jewelry.

Another ring with a blade used for self-defense is U.S. Pat. No. 5,301,432, Apr. 12, 1994, by Stanley G. Richardson, Derry J. Richardson. The utility patent of Richardson et al. relates to a ring blade for cutting or defensive purposes that comprises a ring with a crown piece that houses a retractable blade that can be pivoted on a pin mechanism from a closed position up into an extended position. There are several problems with the Richardson et al. invention. One, when the invention is in the closed position, the blade is still visible and can be accidentally opened into a dangerous position. Two, when the invention is in the open position with the blade extended for self-defense or cutting purposes, there doesn't seem to be any locking mechanism holding the blade in place, and it can be closed or lowered while in use, rendering it inoperable. Three, the ring is bulky and would be burdensome to wear. Four, the Richardson et al. invention is not practical and does not have any aesthetic or ornamental appeal as an everyday piece of jewelry.

A third ring with a blade for self-defense is U.S. Pat. No. 2005/0193,565, Sep. 8, 2005, by Charles Knowles. The patent of Charles Knowles is a self-defense ring device comprising a ring and a side compartment which contains a retractable blade. The Knowles invention is intended to be worn on the user's little finger and the blade can be opened by pushing a spring-loaded lever to extend the blade from the compartment. There are a few problems with the Knowles invention as it relates to a self-defense ring. One, the invention is bulky and big for the user to wear. Two, the invention must be worn on the pinky finger, so it limits the device's wearability. In a self-defense situation, the best location for a blade ring is on the middle finger so that the ring is stabilized and central. Three, it seems that there is no locking mechanism to hold the blade in place once it has been extended and opened. Therefore, the blade can be accidentally closed or moved into an inoperable position during combat. Four, the invention is not practical and does not have any aesthetic or ornamental appeal as an everyday piece of jewelry.

Another self-defense ring is U.S. Pat. No. 20160286910A1, Oct. 6, 2016, by Jodi Fisher. The patent of Fisher is a self-defense ring device comprising a ring and a blade like object. There are several problems with the Fisher invention as it relates to a self-defense ring. One, when the invention is in the closed position, the blade is still visible and exposed presenting a safety hazard to the user. Two, the user must make a fist in order to position the blade into a usable defensive position. However, if the user makes a fist, the blade is parallel to the finger and therefore pointed downwards toward the ground in a fist striking position. The only way to use the device would be to angle the wrist upward so that the blade is pointed forward, which would result in wrist injuries. Three, the invention does not have any aesthetic or ornamental appeal as an everyday piece of jewelry.

### BRIEF SUMMARY OF THE INVENTION

The present invention includes a device used in self-defense comprising a ring configured to be worn on the finger of a user. The ring comprises a base with a blade affixed to the middle of the setting, and a top with an ornamental piece. Wherein said base and top comprise connecting mechanisms to connect.

### BRIEF DESCRIPTION OF THE DRAWINGS

FIG. 1 illustrates a side perspective view of one embodiment of the present invention with the ring base and ring top detached.

FIG. 2 illustrates a side perspective view of one embodiment of the present invention.

FIG. 3 illustrates a side perspective view of the ring base of one embodiment of the present invention.

FIG. 4 illustrates a view of one part of a connecting mechanism of one embodiment of the present invention.

FIG. 5 illustrates one embodiment of the present invention.

FIG. 6 illustrates one embodiment of the present invention.

FIG. 7 illustrates one embodiment of the present invention.

### DETAILED DESCRIPTION OF THE INVENTION

The present invention will now be described more fully hereinafter with reference to accompanying drawings, in which some, but not all embodiments of the invention are shown. Various embodiments, variations, materials, forms, and parts are disclosed in this patent, but not all of the variations are described or shown. Indeed, these present inventions may be embodied in many other different forms, embodiments, variations, materials and parts, and should not be construed as limited to the embodiments and variations set forth herein; rather these embodiments are one of the preferred embodiments and variations in order to satisfy all applicable legal requirements.

The present invention can solve prior art problems due to one or more of its practicality, accessibility, multi-functionality, and aesthetic appeal. The present application discloses a small, light, easily accessible device that can function both as an everyday, ornamental jewelry ring, and as a sharp self-defense blade weapon.

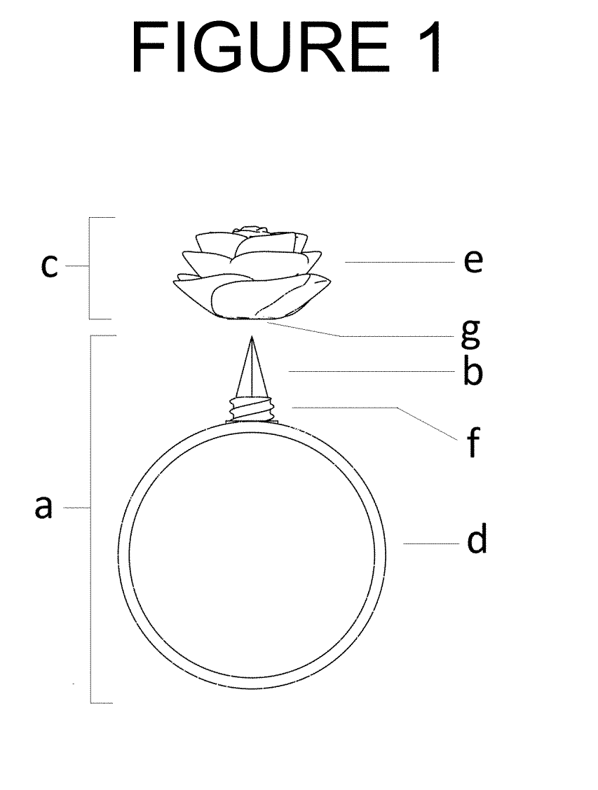

FIG. 1 illustrates a self-defense ring device according to an embodiment of the present invention. The self-defense ring comprises a ring base (a), a blade (b), and a ring top (c). The ring base (a) comprises a ring band (d) and blade (b), and a base connecting mechanism (f). The ring top (c) comprises an ornamental top (e), and a top connecting mechanism (g). Ring top (c) is able to be detached and attached to ring base (a) via base connecting mechanism (f) and top connecting mechanism (g). The ring device is able to provide the user with a beautiful, everyday ring that can quickly be transformed into a sharp blade used for self-defense.

The ring band (d) in FIG. 1 can be a typical ring band that a user can wear as a piece of jewelry on her/his finger. The ring band (d) can be worn at the base of a finger, fitting snugly and securely around the finger's base circumference. The ring band (d) can be made of any material or metal including, but not limited to, plastic, wax, stainless steel, silver, gold, platinum, titanium, brass, bronze, copper, nickel, rhodium, cobalt, tungsten, palladium, wood, resin, ceramic, silicone, or any combination of these materials. The ring band (d) can be of any color, width, length, height, depth, thickness, diameter, circumference, density or ring size suitable for a user. In an example embodiment, the ring band (d) can be made of a steel metal material, a grey color, ring size 7, diameter of 20 mm, band width of 3 mm, and band thickness of 2 mm. In other embodiments, the ring band (d) can be a ring size from about 3 to about 14, including, but not limited to ring size 3, 3.5, 4, 4.5, 5, 5.5, 6, 6.5, 7, 7.5, 8, 8.5, 9, 9.5, 10, 10.5, 11, 11.5, 12, 12.5, 13, 13.5, and 14. In other embodiments, the ring band (d) can be a band width from about 0.5 mm to about 10 mm, including, but not limited to 0.5 mm, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, and 10 mm. In other embodiments, the ring band (d) can be a band thickness from about 0.5 mm to 8 mm, including, but not limited to 0.5 mm, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, and 8 mm.

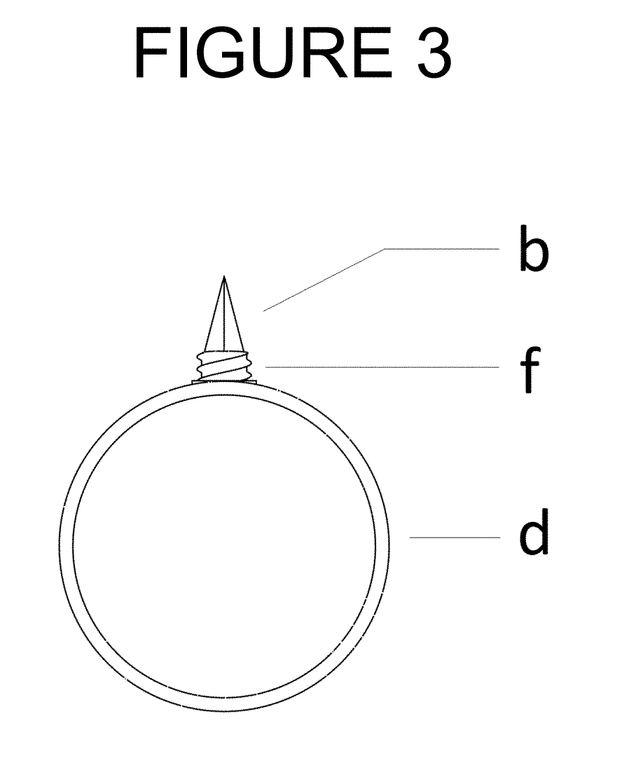

The base connecting mechanism (f) in FIG. 3 can provide two functions. A first function may provide a platform for the blade (b) for stability, elevation, and safety. A second function may provide a connecting mechanism for the ring base (a) and ring top (c) to securely connect. The base connecting mechanism (f) can be of any shape, design or mechanism as to accomplish the function of connecting two pieces together. According to the illustrated embodiment, the base connecting mechanism (f) is a cylindrical-shaped, male bolt-threaded platform, similar to, for example, a bolt or screw in appearance, shape, and function. The base connecting mechanism (f) can be made of any material or metal including, but not limited to, plastic, wax, stainless steel, silver, gold, platinum, titanium, brass, bronze, copper, nickel, rhodium, cobalt, tungsten, palladium, wood, resin, ceramic, silicone, or any combination of these materials. The base connecting mechanism (f) can be of any color, width, length, height, diameter, depth, circumference, or density. In one embodiment, the base connecting mechanism (f) can be a steel metal material, grey color, 3.5 mm in diameter and 1.5 mm in height. In other embodiments, the base connecting mechanism (f) can have a diameter of about 1 mm to about 14 mm, and a height of about 0.1 mm to about 20 mm.

The blade (b) in FIG. 3 can be a typical sharp object. Some embodiments can be a double-blade with two (2) sharp objects that are mounted separately, or a crisscross blade with two (2) sharp objects that intersect at the middle of each of their respective center points. The blade (b) can be made of any material or metal including, but not limited to, steel, silver, gold, platinum, titanium, brass, bronze, copper, nickel, rhodium, cobalt, tungsten, palladium, plastic, wax, wood, resin, ceramic, silicone, alloy, or any combination of these materials. The blade (b) can be of any color, shape, width, length, height, depth, density, sharpness, or design. In one embodiment, the blade (b) can be a steel material, triangular shaped, double-sided with thin edges and a slightly thicker grind or spine, grey color, about 2 mm in width at the base, about 4 mm in height/length, and about 1 mm in depth at the spine. In other embodiments, the blade shape or style can be single-sided or multi-sided, serrated-edged, straight-edged, hollow-edged, crisscrossed with multiple blade cheeks, needle-pointed, spear-pointed, curved similar to for example a talon blade, wide similar to for example an axe blade, or any other blade type that can be used for cutting or self-defense. Additionally, in other embodiments, the blade can have a diameter or width of about 0.1 mm to about 25 mm, a height of about 0.1 mm to about 60 mm, and a depth of about 0.1 mm to about 20 mm.

The ring band (d), the base connecting mechanism (f), and the blade (b) can be permanently joined together as one piece. The base connecting mechanism (f) bottom can be affixed to the outer circumference of the ring band (d). The base connecting mechanism (f) can be aligned with the ring band's (d) central longitudinal axis, and at a 90-degree perpendicular angle to the ring band's central latitudinal axis. The base connecting mechanism (f) can face upward and outward away from the finger similar to, for example, the perpendicular angle and position of a diamond on an engagement ring.

The blade (b) can be affixed to the top circular plane surface of the base connecting mechanism (f) head. The blade (b) can extend upward and outward away from the finger, aligning with the ring band's (d) central longitudinal axis. The ring band (d), base connecting mechanism (f) and blade (b) can all be permanently affixed together by being cast together, manufactured together, stamped together, welded together, glued together, assembled together with or without hardware, brazed together, melted together, or soldered together, or any method of joining two or more separate pieces permanently together.

In some embodiment, the blade (b) may be joined to the outer circumference of the ring band (d) and the base connecting mechanism is affixed around the blade (b) at the connection to the ring band (d).

In some embodiment, the base connecting mechanism (f) and blade (b) are one piece, and the ring band (d) is one piece. The ring band (d) has an empty cavity in it, so that the base connecting mechanism (f) and blade (b) piece can be stamped into it, or any other method of joining two or more pieces together.

The ring top (c) in FIG. 1 comprises an ornamental top (e) and a top connecting mechanism (g). The ornamental top (e) and top connecting mechanism (g) can be one piece. The top connecting mechanism (g) can be joined to the bottom portion of the ornamental top (e). The ornamental top (e) and top connecting mechanism (g) can be permanently affixed together by being cast together, manufactured together, stamped together, welded together, glued together, assembled together with or without hardware, brazed together, melted together, or soldered together, or any method of joining two or more separate pieces permanently together.

The ornamental top (e) can be of any design, color, style, shape, material, or size. According to the illustrated embodiment, the ornamental top (e) can be a rose flower design. The rose flower design ornamental top can be a silver material, grey color, about 7 mm in diameter and about 7 mm in height. In other embodiments, the ornamental top can be floral or flower designs, shapes, abstract shapes and designs, animals, environment or nature, pearls, objects, diamonds, stones, gems, minerals, crystals, patterns, figures, or any other ornamental design top.

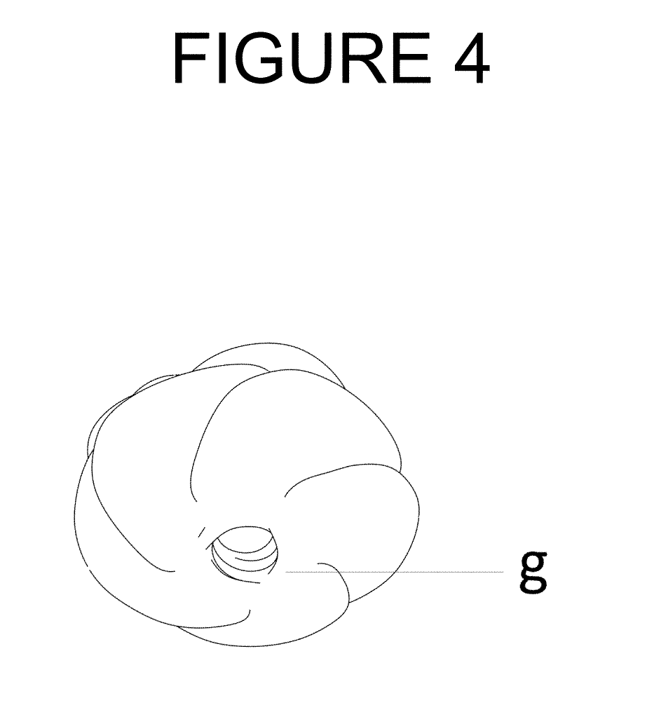

The top connecting mechanism (g) in FIG. 4 can provide a functionality that enables a connection of the ring base (a) to the ring top (c) via being attached to the base connecting mechanism (f) on the ring base (a), as presented in FIG. 1. The top connecting mechanism (g) can be of any material, shape, design or mechanism as to accomplish the function of connecting two pieces together. According to the embodiment presented in FIG. 4, the top connecting mechanism (g) can be a hollow cylindrical-shaped, female nut-threaded hole similar to, for example, a nut fastener in appearance, shape, and function. The top connecting mechanism (g) can be made of any material or metal including, but not limited to, plastic, wax, steel, silver, gold, platinum, titanium, brass, bronze, copper, nickel, rhodium, cobalt, tungsten, palladium, wood, resin, ceramic, silicone, alloy, or any combination of these materials. The top connecting mechanism (g) can be of any color, width, length, height, depth, diameter, circumference, or density. In one embodiment, the top connecting mechanism (d) can be a steel metal material, a grey color, about 7 mm in diameter, and about 3 mm in height. In other embodiments, the top connecting mechanism (g) can have a diameter of about 0.5 mm to about 18 mm, and a height of about 0.1 mm to about 25 mm.

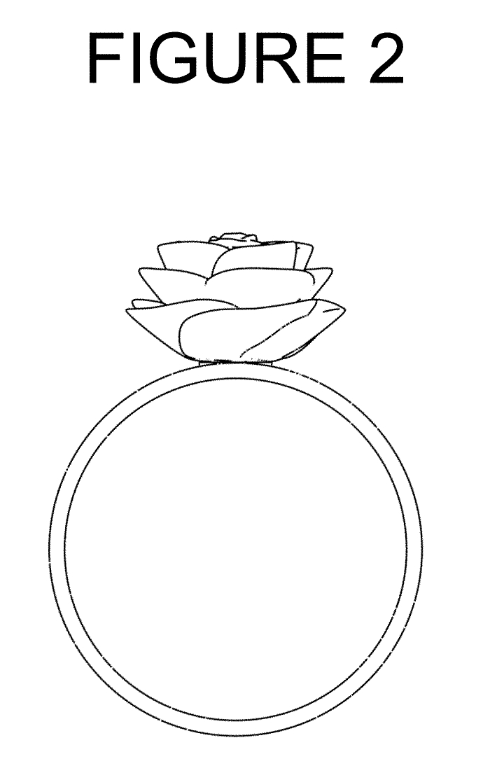

The illustrated embodiment in FIG. 2 can be regularly worn as an ornamental everyday jewelry ring with the ring top (c) attached to the ring base (a). The present embodiment including the ring base (a) and ring top (c) can be generally designed to be worn at the base of the middle finger of the user but can be worn on the thumb finger, pointer finger, ring finger, or pinky finger as well.

The user can perform any and all regular activities while wearing the present invention, including for example, cooking, eating, working, typing, writing, walking, jogging, running, exercising, driving, holding items, carrying bags, and any other normal activity.

In a self-defense situation, the user can unsheathe the blade (b) by detaching the ring top (c) from the ring base (a). In one embodiment, the user can detach the ring top (c) from the ring base (a) by unscrewing in a counter-clockwise direction the ring top (c) in order to disconnect the top connecting mechanism (g) from the base connecting mechanism (f). If the user is right-handed and has the ring on her/his dominant right hand, s/he can use her/his left hand to unscrew the ring top (c) in a counter-clockwise direction. A user with average motor skills can unscrew the ring top (c) in a couple of seconds (e.g., two seconds) or less, which demonstrates that it's immediately accessible, readily available, and ready to use. Other self-defense products can take up to or more than thirty (30) seconds in order to locate the product in one's bag, retrieve it, open it, and arm it.

In a self-defense situation once the blade has been unsheathed, the user can make a fist as one would naturally do to defend herself/himself. The fist position would effectively secure the ring and blade to the user's hand, arm, and body, making it difficult for an attacker to knock off. The user can defend herself/himself by extending her/his arm and punching, swinging, cutting, poking, or slashing, or any other method of using a blade as a self-defense weapon.

The present invention can be an effective self-defense weapon in several ways. It can deter an attacker if s/he sees the blade and realizes the user is prepared to defend herself/himself with a sharp weapon. It can also deter an attacker if s/he is injured, bleeding, in pain, or surprised by the damage of the blade. Some attackers who may be mentally unstable or under the influence of drugs or alcohol, may not be deterred after being cut by the blade. Even in this worst-case scenario, the victim can at least have the ability to cut the skin of, or draw blood from the attacker for forensic and DNA purposes. In addition, the present invention can instill confidence in users, and give them peace of mind that they can defend themselves a lot more effectively than if they were not wearing this self-defense ring.

Following a self-defense situation, the user can sheathe or hide the blade (b) by attaching the ring top (c) to the ring base (a) to encase the blade. In an embodiment of the present invention, the user can attach the ring top (c) to the ring base (a) by screwing in a clockwise direction the ring top (c) in order to connect the top connecting mechanism (g) to the base connecting mechanism (f), similar to, for example, screwing a nut fastener on to a bolt screw.

A blade such as the one described in the present application can be an ideal self-defense weapon for several reasons. Sharp blades can inflict a lot of bodily harm and damage to an attacker, and can inflict a relatively large amount of bodily harm and damage to an attacker with a low amount of force and speed, including for example, in close quarters or while the victim is subdued or being held. A blade can be small, light, not bulky like other weapons, and carried or worn every day without burdening the user. A blade also does not require regular maintenance like guns, charging like stun guns, or refilling of liquids like pepper spray.

A fixed blade, as the one described in the present application, can also be a more ideal self-defense weapon compared to a movable blade. In a self-defense situation, a fixed blade can be more stable and less likely to be accidentally closed, shifted, or broken off. A fixed blade requires less mechanisms and storage which decrease the bulkiness, size and weight of the self-defense product.

A ring can be an ideal self-defense weapon because it can be worn every day as a regular, beautiful, ornamental piece of jewelry on a user's finger. The ring can be immediately accessible mounted on a user's finger, and securely worn around the user's finger making it nearly impossible to knock off, especially if the user makes a fist during a self-defense situation. The ring can be small, light, not bulky, and requires minimal space on the user's hand, and requires no space in the user's pocket, purse, and bag.

The base connecting mechanism (f) and top connecting mechanism (g), which described in the present application can be a base male bolt-style fastener platform and a top female nut-style fastener hole, respectively, can provide great versatility and functionality. The connecting mechanisms can be small grooves that are built into the invention itself, which take up very little space. The base connecting mechanism (f) and top connecting mechanism (g) can have substantially similar diameters and circumferences, with one of the connecting mechanism's diameter and circumference being slightly greater, thereby allowing the parts to connect with minimal space wasted and maximum attachment strength. The connecting mechanisms can also allow for the quick detaching of the ring parts in order to unsheathe the blade in a sudden self-defense situation.

The base connecting mechanism (f) and top connecting mechanism (g) can be described in other embodiments, including, but not limited to, as a buckle mechanism, latch mechanism, snap-on mechanism, spring release mechanism, squeeze mechanism, locking mechanism, basic push-together mechanism, suction mechanism, pressurized mechanism, pressure assembly mechanism, magnetic mechanism, track mechanism, friction mechanism, an adhesive, or any other mechanism used to connect two things together.

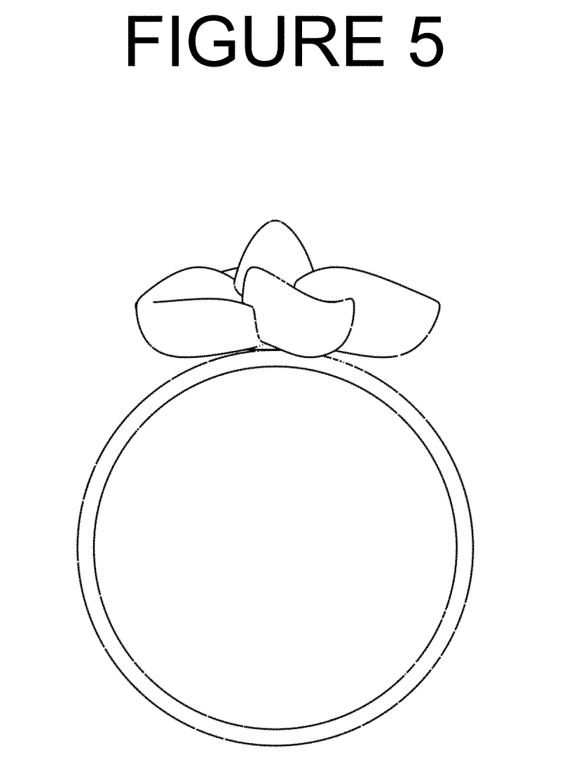

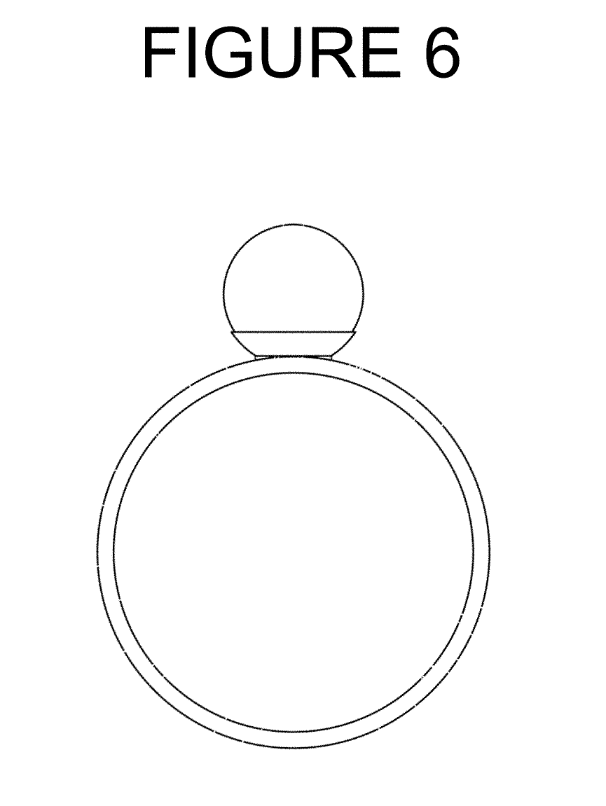

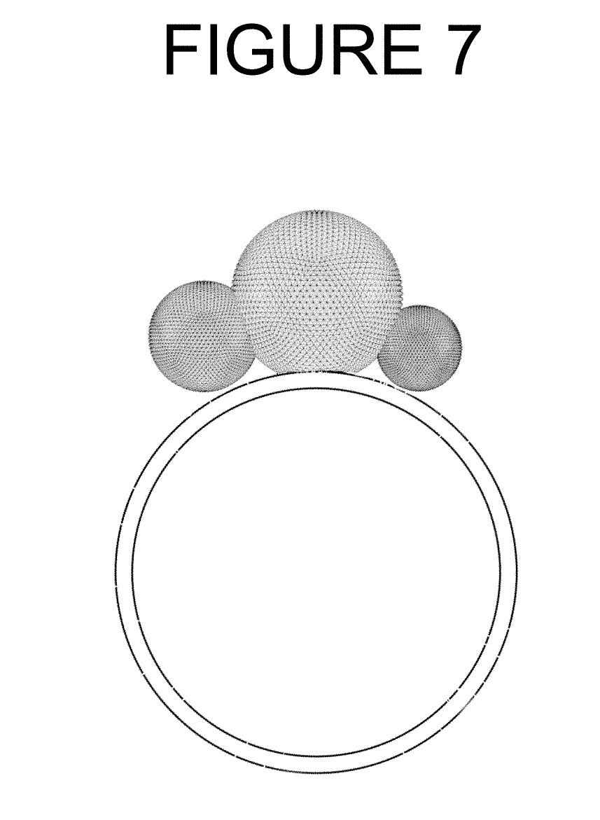

The ornamental top (e) can provide ornamental and aesthetic appeal as a piece of jewelry, and versatility to the ring device described in the present application. The ring is capable of being used with a variety of interchangeable ornamental tops including, but not limited to, stones, gems, diamonds, pearls, minerals, crystals, amethyst, turquoise, sapphire, emerald, morganite, garnet, topaz, opal, ruby, onyx, tanzanite, zircon, or any combination of these materials. In addition, the ornamental top can be described in other embodiments including, but not limited to, designs, shapes, abstracts, objects, settings, patterns, figures, animals, or any combination of these parts that are made using a material including but not limited to glass, metal, plastic, wax, steel, silver, gold, platinum, titanium, brass, bronze, copper, nickel, rhodium, cobalt, tungsten, palladium, wood, resin, ceramic, silicone, alloy, or any combination of these materials. One embodiment of the ornamental top (e) can be a sphere-shaped pearl design in FIG. 6 with a white top to represent a pearl made of silver, or a real or fake pearl, and about 6 mm in height, depth, and width. Some embodiment of the ornamental top (e) can be a plumeria flower design in FIG. 5 with about five (5) petals and one (1) center bulb, made of silver, about 8 mm in height, and 8 mm in width. Some embodiment of the ornamental top (e) can be a set of three (3) spheres in FIG. 7 connected at their center points, all varying in sizes with the center sphere being the biggest, a silver material, about 6 mm in height, and 5 mm in width. One embodiment of the ornamental top (e) can be a prong setting and a stone, similar to, for example, a typical diamond ring. The prongs can encase the blade (b) and hold the stone above the tip of the blade (b). In this embodiment, the top connecting mechanism (g) can be affixed to the base of the prongs setting (e). Other embodiments for the ornamental top (e) include, but are not limited to, flowers such as daisies, lilies, carnations, daffodils, geraniums, hibiscus, iris, lavender, lilac, magnolias, orchids, sunflowers, tulips, violets, asters, marigold, peony, and primrose. Other embodiments for the ornamental top (e) include, but are not limited to, shapes and abstracts such as triangles, squares, rectangles, circles, cylinders, cones, semicircles, octagons, ovals, pentagons, cubes, spheres, pyramids, hexagons, rhombus, tetrahedron, prisms, crescents, polygons, kites, trapezoids, hearts, stars, moons, droplets, tears, crosses, arrows, pies, and ellipses. Other embodiments for the ornamental top (e) include, but are not limited to, animals like dogs, cats, birds, fish, apes, bears, insects, bees, butterflies, cheetah, dolphin, eagle, elephant, fox, horse, lion, lizard, moose, mouse, pig, panda, rabbit, scorpion, seal, shark, snake, spider, tiger, whale, wolf, and zebra. Other embodiments for the ornamental top (e) include, but are not limited to, nature such as boulders, mountains, volcanoes, trees, plants, cliffs, clouds, cosmos, horoscope signs, planets, forest, glaciers, icebergs, leaves, rivers, rocks, snow, and vistas. Other embodiments for the ornamental top (e) include, but are not limited to, foods, fruits, vegetables, desserts, sweets, nuts, and drinks.

While the foregoing written description of the present invention enables a person of ordinary skill in the art to make and use what is considered presently to be the best mode thereof, those of ordinary skill will understand and appreciate the existence of variations, combinations, alternatives, and equivalents of the specific embodiment, method, and examples herein. The invention should therefore not be limited by the above described embodiment, method, and examples, but by all embodiments and methods within the scope and spirit of the invention.

What is claimed is:

1. A ring, comprising:
a) a ring base comprising:
i) a band, that is configured to be worn on a finger of a user;
ii) a blade that is fixed to an outer circumference of the band, wherein the blade protrudes from the outer circumference of the band;
iii) a base-connecting mechanism joined to a portion of the blade that is fixed to the outer circumference of the band; and
b) a ring top, comprising:
i) an ornamental top; and
ii) a top-connecting mechanism joined to a bottom portion of the ornamental top.

2. The ring of claim 1, wherein the blade is a sharp object with a pointed tip with a blade base width of about 1 mm to about 9 mm and a blade height of about 1 mm to about 20 mm.

3. The ring of claim 1, wherein the blade is a metal material, triangular shaped, double-sided with thin edges and a slightly thicker grind or spine.

4. The ring of claim 2, wherein the blade is a metal material, triangular shaped, double-sided with thin edges and a slightly thicker grind or spine.

5. The ring of claim 1, wherein the base-connecting mechanism is a cylindrical-shaped, male bolt-threaded platform.

6. The ring of claim 1, wherein the top-connecting mechanism is a hollow cylindrical-shaped, female nut-threaded hole.

7. The ring of claim 1, wherein the ornamental top is a rose design decorative piece.

8. The ring of claim 1, wherein the ring band is a circular object of about ring size 7, and a ring band width of about 1.5 mm to about 5 mm.

9. The ring of claim 1, wherein the ring base and ring top are attached via a base connecting mechanism and top connecting mechanism being connected.

10. The ring of claim 1, wherein the blade is made of a metal, plastic, wax, wood, resin, ceramic, glass, alloys, or silicone.

11. The ring in claim 1, wherein the base connecting mechanism and top connecting mechanism are made of a metal, plastic, wax, wood, resin, ceramic, glass, alloys, or silicone.

12. The ring of claim 1, wherein the ornamental top is made of a metal, plastic, wax, wood, resin, ceramic, glass, stone, alloys, or silicone.

13. The ring of claim 1, wherein the base connecting mechanism and top connecting mechanism are two pieces that can attach or detach from each other.

14. The ring of claim 1, wherein the base connecting mechanism is a screw thread bolt, and the top connecting mechanism is a corresponding nut thread hole, that is shaped to form around the base connecting mechanism screw thread bolt.

15. A ring for use in self-defense, comprising:
a) a ring base comprising:
i) a band, that is configured to be worn on a finger of a user;
ii) a base connecting mechanism affixed to the top outer circumference of the band;
iii) a blade that is affixed to the top circular plane of the base connecting mechanism head, wherein the blade protrudes from the top of the base connecting mechanism; and
b) a ring top comprising:
i) an ornamental top; and
ii) a top connecting mechanism joined to a portion of the ornamental top.

16. A method for self-defense comprising:
a) placing a self-defense ring device on a finger;
b) detaching a ring top of the ring device from a ring base of the ring device;
c) unsheathing a blade portion of the ring device per removal of ring top; and
d) protecting oneself by using the blade portion to deter or disable an offender.

17. The method of claim 17 further comprising securing the self-defense ring device on a finger by making a fist.

18. The method of claim 17 further comprising protecting oneself by engaging in physical movement and combat using the self-defense ring device.

19. The method of claim 17 wherein the self-defense ring device comprises the blade portion affixed to a ring band at the ring base, the ring base including a connecting mechanism, and a ring top secured to the ring base via the connecting mechanism.

20. A method for self-defense comprising:
unsheathing a blade portion of a ring device by detaching a ring top from a ring base, the ring device comprising the blade portion affixed to a ring band at the ring base, the ring base including a connecting mechanism, and a ring top secured to the ring base via the connecting mechanism.
